(19) United States
(12) Patent Application Publication
(10) Pub. No.: US 2002/0075231 A1
(43) Pub. Date: Jun. 20, 2002

(54) Adaptable remote control with exchangeable controls

(75) Inventors: Jaquelyn Annette Martino, Cold Spring, NY (US); Lira Nikolovska, Eindhoven (NL)

Correspondence Address: Jack E. Haken, Corporate Patent Counsel, U.S. Philips Corporation, 580 White Plains Road, Tarrytown, NY, 10591, US

(73) Assignee: Philips Eelectronics North America

(21) Appl. No.: 09/739,512

(22) Filed: Dec. 18, 2000

(51) Int. Cl. G09G 5/08

(52) U.S. Cl. 345/158

(57) ABSTRACT

A user interface in the form of a string of beads allows specific data sets, each corresponding to one of the beads, to be employed for various purposes through manipulation of the beads, optionally with a console. For example, selected portions of a first data set associated with a first bead can be transferred to a data set associated with a second bead by interfacing both beads consecutively with a console. The console can then be used to enter specific commands for selecting the data to be transferred. In another application, the data sets are used to filter the delivery of programming visible through an electronic program guide for a television. The user holds beads, each corresponding to a criterion or set of criteria to be used for filtering. Heat sensor switches in the beads cause only the held beads to send identifiers uniquely identifying each bead to the console. Identifiers of the corresponding data sets are sent to the media delivery device.

### BACKGROUND OF THE INVENTION

1. Field of the Invention

The invention relates to remote controls and more particularly to remote controls that can be personalized and which are capable of sharing information with other remote controls.

2. Background

Programmable, and thereby customizable, remote controls are known. For example, a product made by Philips Electronics Corp. called Pronto® allows a user to program her/his own controls into a hand-held remote. For example, the controller could be programmed to have a “favorites” button that only switches between selected favorite channels. An example of such a device is described in U.S. Pat. No. 5,327,160, filed Nov. 16, 1992. Also known are customizable broadcast control devices which allow a user's preferences for broadcast content to be stored and used to filter selections. Another unrelated area of technology is personal digital assistants (PDAs). A PDA is able to communicate any form of personal information to another PDA. Another unrelated area of prior art is radio frequency identification (RFID), which have been proposed to be used for all manner of identification and authentication of goods, persons, fund accounts, etc.

### SUMMARY OF THE INVENTION

The present invention is a novel combination of selected features, some of which may be known respectively in the fields of customizable remote controls, PDAs, and RFID systems. Briefly, according to the invention, criteria defining preferences of a user are associated with objects which may be manipulated to perform the functions of recording user preferences regarding a controlled device such as a television, ranking choices of the device, controlling a selector of the device, and transferring recorded preferences, such as rankings, between such objects.

According to an illustrative embodiment, the invention is a string of bead-shaped devices each of which corresponds to a criterion, or set of criteria, for filtering or sorting media content. The string as a whole may be used to control a television, video, or Internet broadcast device. For example, a first bead may correspond to genre, a second bead to time of day, a third to a preference profile of a person other than the user, and a fourth to a preference profile of the user. The string also includes a console to allow the user to communicate preferences with respect to the beads to a set-top box that controls a television and electronic program guide (EPG). One way of using the beads is to hold a bead, say the genre bead, against electrical contacts on the console. The console may include a display and control buttons that permit the user to scroll through genre choices that may be added or subtracted from a set of currently-selected genre choices. When finished, the user can then transmit, using the console, the genre choices so-selected. The other category beads, such as time of day, may be used to make similar selections. Once completed, the complete set of preferences (a profile) with respect to each criterion may be used to filter the display of an electronic program guide by touching the user's bead to the console and actuating a control requesting that the profile be used to filter the display. The latter request may be invoked by pressing a button on the console for “Use” or “Apply.”

Alternatively, the bead may merely have a unique identity which corresponds to data stored somewhere else, for example on the console or in the set-top box. The preferences may even be stored on a web-site.

The console may contain wireless transceivers to allow communication with other consoles and with the set-top box or other devices such as kiosk terminals in shopping malls that give custom shopping advice based on user-preferences. Using the ability of the consoles to communicate with each other, a user could share certain preferences or other data with another user, and the receiver could associate the received data with a new bead. Since each bead is unique, the user need only add another bead to his/her string and establish a download ministered by a control program on the consoles in the manner of current PDA devices.

It is contemplated that the above invention may be used in connection with many different kinds of data. For example, a bead could be associated with email, a gift registry, a list of favorite books, or a ranking of web-sites. These objects may be duplicated at will, since they only need to have their unique code associated with a unique data set. In this way, they could be automatically updated by another person at the place where the data is stored, always giving the person accessing the data a view of only the latest data set.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWING

FIG. 1 is an illustration of a base station system than can support some embodiments of the invention.

FIG. 2A is an illustration of a console and bead in communication with the console according to an embodiment of the invention.

FIG. 2B is a functional block diagram of elements of the console and a bead from FIG. 1A.

FIG. 3 is an illustration of a console and beads on a string illustrating different category beads according to an embodiment of the invention.

FIG. 4 is an illustration of two beads from separate users in communication according to an embodiment of the invention.

FIG. 5 is an illustration of a user interface supporting communication between beads from separate users according to an embodiment of the invention.

FIG. 6 is an illustration of a user interface for programming a genre bead according to an embodiment of the invention.

FIG. 7 is an illustration of a user interface for programming a channel bead according to an embodiment of the invention.

FIG. 8 is an illustration of a user interface for programming a key word bead according to an embodiment of the invention.

FIG. 9 is an illustration of a bead string in which beads have displays according to an embodiment of the invention.

FIG. 10 is an illustration of a simple mechanism for indicating when a bead is being activated by a user according to an embodiment of the invention.

### DETAILED DESCRIPTION OF THE PREFERRED EMBODIMENTS

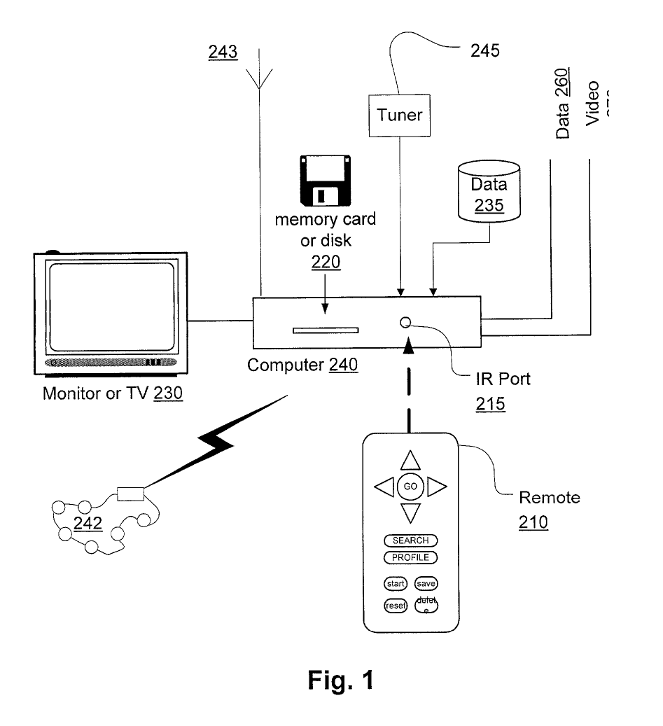

Referring to FIG. 1, the invention relates to database storage, search, and retrieval using physical objects that have functional associations that make it easy and intuitive to perform certain actions. The invention may be used in connection with search and visualization tasks in connection with electronic program guides (EPGs). In the context of televisions, EPG is applied loosely to various features that can be delivered using a database of program information. The program information may include titles and various descriptive information such as a narrative summary, various keywords categorizing the content, etc. In an embodiment, a computer 240 sends program information to a television or monitor 230. The computer 240 may be equipped to receive a video signal 270 and control the channel-changing function, and to allow a user to select channels through a tuner 245 linked to the computer 240 rather than through a tuner in the television. The user can then select the program to be viewed by highlighting a desired selection from the displayed program schedule using the remote control 210 to control the computer. The computer 240 has a data link 260 through which it can receive updated program schedule data. This could be a telephone line connectable to an Internet service provider or some other suitable data connection. The computer 240 has a mass storage device 235, for example a hard disk, to store program schedule information, program applications and upgrades, and other information. Information about the user's preferences and other data can be uploaded into the computer 240 via removable media such as a memory card or disk 220.

Note that many substitutions are possible in the above example hardware environment and all can be used in connection with the invention. The mass storage can be replaced by volatile memory or non-volatile memory. The data can be stored locally or remotely. In fact, the entire computer 240 could be replaced with a server operating offsite through a link. Rather than using a remote control to send commands to the computer 240 through an infrared (IR) port 215, the controller could send commands through a data link 260 which could be separate from, or the same as, the physical channel carrying the video. The video signal 270 or other content can be carried by a cable, RF, or any other broadband physical channel or obtained from a mass storage or removable storage medium. It could be carried by a switched physical channel such as a phone line or a virtually switched channel such as ATM or other network suitable for synchronous data communication. Content could be asynchronous and tolerant of dropouts so that present-day IP networks could be used. Further, the content of the line through which programming content is received could be audio, chat conversation data, web sites, or any other kind of content for which a variety of selections are possible. The program guide data can be received through channels other than the separate data link 260. For example, program guide information can be received through the same physical channel as the video or other content. It could even be provided through removable data storage media such as memory card or disk 220. The remote control 210 can be replaced by a keyboard, voice command interface, 3D-mouse, joystick, or any other suitable input device. Selections can be made by moving a highlighting indicator, identifying a selection symbolically (e.g., by a name or number), or making selections in batch form through a data transmission or via removable media. In the latter case, one or more selections may be stored in some form and transmitted to the computer 240, bypassing the display 170 altogether. For example, batch data could come from a portable storage device (e.g. a personal digital assistant, memory card, or smart card). Such a device could have many preferences stored on it for use in various environments so as to customize the computer equipment to be used.

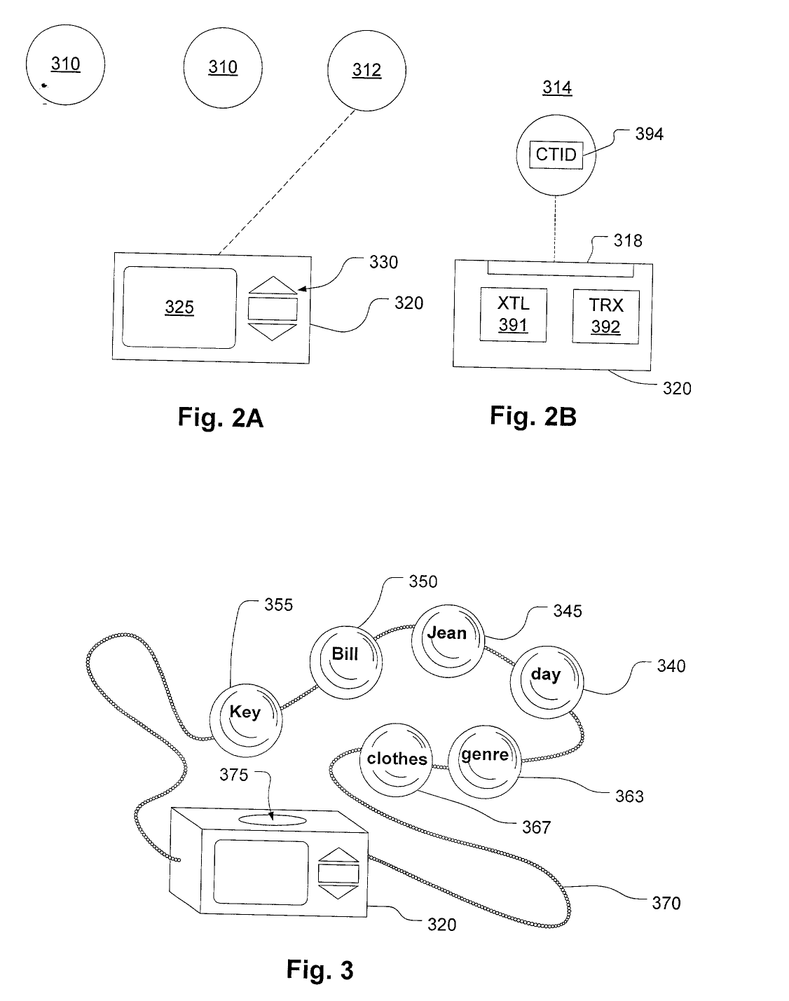

A remote control/storage device 242 communicates with the computer 240 via a wireless link such as via the IR port 215 or a radio link employing an antenna 243. Referring to FIGS. 2A, 2B, and 3, the remote control/storage device 242 includes a console 320 and a plurality of beads 310 and 312. The console has a transceiver 392 for communicating with the computer 240, an interface 318 for interoperating with beads 310, 312 (as discussed below), and a controller 391, preferably a programmable controller. Each bead 314 contains some means for distinguishing itself from the other beads 314. For example, there may be a chip with a unique identifier programmed into it combined with a transponder (collectively shown at 394). In an embodiment, the console 320 and beads 310, 312 are all linked by a string or chain 370. Each bead 310/312 is uniquely identified by a code. The code may be encoded as the value of a resistance incorporated in the bead 310, for example, encoded in a transponder device built into the bead 310, or formed as a reflective pattern in the bead surface to be scanned by the console. Any of a variety of different mechanisms for making the beads 310 self-identifying may be used. Note that the bead's uniqueness may only be with respect to the particular console 320. All communications between the beads 310 and the outside world go through the console, in this embodiment, so as long as each bead 310 is distinguishable from the others and the console 320 is unique with respect to consoles of other users (e.g., using a serial number stored on a “smart chip”), then each bead can be unique. To make it easy for users, the beads could be sold with a color or color pattern, picture, shape or other characteristic that makes it unique and insures it can be distinguished from other beads on a string.

In use, a link is generated between one of the beads 312 and the console 320. This link may be established, for example, by placing the bead 312 in a recess 375. Certain features associated with the bead's 312 meaning can then be accessed based on the programming of either or both of the console 320 and/or the computer 240. When bead 312 is placed in the console 320, the console reads the unique identifier of the bead and employs any of a variety of mechanisms for generating a user interface protocol as a result.

The particular type of user interface that results depends on what the bead represents. For example, the bead might represent a shopping list. If the latter, the console may generate a current list of items and permit the user to add or delete items from it. One mode of adding an item could consist of pressing the clothing list bead 367 to the console's recess 375 while, or after, an advertisement showing the item aired in a television broadcast. So-called digital TV devices, connected to the computer 240 or incorporated within it, would provide for the automatic addition of that item to a database storing a clothing list associated with the clothing list bead 367. Another way of updating such a list might be by using a bar code scanner (not shown) built into the console 320. The user would scan bar code symbols representing items to be added to the list, such as UPC symbols of products.

If multiple related beads 310 are pressed into the recess 375 without interacting with a user interface generated in response thereto, a cumulative user interface may be generated. For example, suppose the user wanted to update both the genre and key word criteria that are in his/her preference profile. The user may momentarily press the key bead 355 and the genre bead 363 into the recess 375. In response, the console 320 would provide the user the ability to make selections from both the genre and key word lists. Once the new selections are made, the user may press the user's own profile bead, for example a Jean bead labeled “Jean” 345, and the console may allow the user to combine the modified criteria lists with the profile associated with the Jean bead 345.

The profile beads could be used in another way. Suppose a user has two profile beads, one for a friend, say a Bill bead 350 for Bill, and one for the user, Jean bead 345. The system (on computer 240, for example) may be programmed to generate a user interface that allows parts of the friend's profile to be combined with the profile of the owner of the console, namely Jean. To invoke this process, the Bill bead 350 might be pressed into the recess 375 followed by pressing the Jean bead 345 into the recess 375. In this way, manipulating the beads is a metaphor for a software process that is to desired to be invoked.

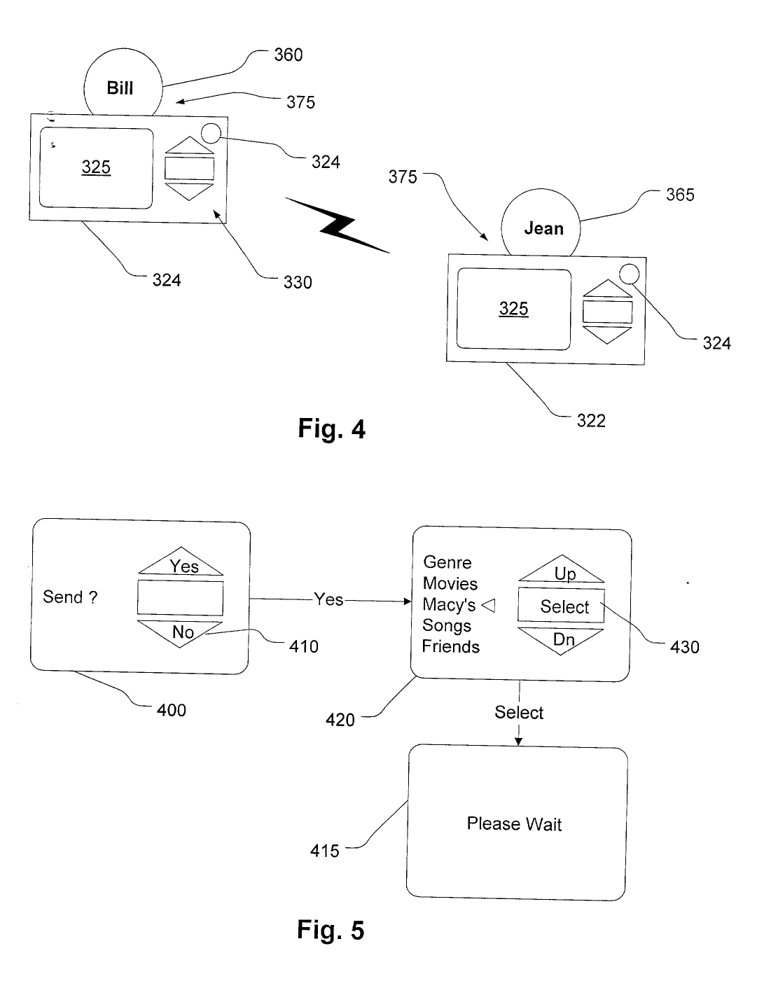

Referring to FIG. 4, in another embodiment, two consoles 324 and 322 communicate via a wireless interface. The latter may be a radio link, an RF link, an audio link, an optical link, an electrical contact link or any other suitable data communications interface. In this example one user's remote control/storage device transfers data to another user's remote control storage device. An owner, Bill, has placed his profile bead, the Bill bead 360, in the recess 375 of his console 324 and a friend Jean has placed her profile bead 365 in the recess 375 of her console 322. Once the link is established and the Bill and Jean beads 360 and 365 are in place, the user interfaces of each console may confirm a transfer of data. The user interface generated on the displays 325 may permit the users to select particular parts of the data to transfer and may permit the selection of a direction: Bill-to-Jean, Jean-to-Bill, or both.

The user interface of the console may include a display 325, scroll and mode buttons 330 or any suitable input devices as necessary to permit the making of selections as discussed above.

Referring to FIG. 5, in an example user interface display 325 to support the transfer discussed with reference to FIG. 4, a user responds in the affirmative to a display 400 asking to confirm that a data transfer is requested. Here the screen shows “soft keys” 410, that is, illustrations of the buttons 330 with labels on them to show the respective functions for purposes of the current options, which are in this case whether to confirm that the user wants to “send” profile data to another bead. The next screen 420 permits the user to select the particular data sets. The select button may be used to mark an entry in a list as displayed. In this case, each of these data sets may correspond to a separate bead on the sender's remote control/storage device. The last screen may be displayed while any necessary communication is going on.

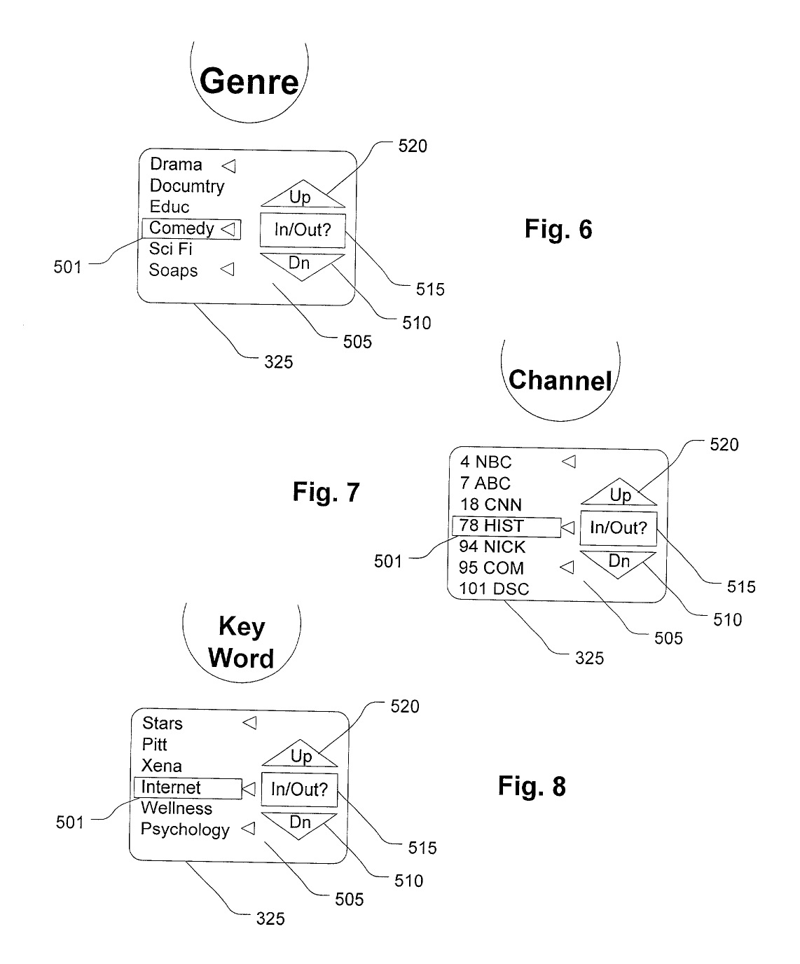

Referring to FIGS. 6, 7, and 8, to indicate the preferences that make up a profile, items may be selected from among various lists, each corresponding to a an independent criterion. FIG. 6 shows a genre list. In it, the items drama, comedy, and soaps have been selected. The selection indicates that these genres are used to filter any data sets to which they correspond when the control/storage device is used with a given base device such as the computer 240. The soft-keys with labels Up and Down indicate the corresponding ones of buttons 330 that may be pressed to perform the function of scrolling up and down the list respectively to move the item to a highlight bar 501. The item highlighted by the highlight bar 501 may be selected or deselected from the list by pressing the In/Out button 515. A similar display is shown in FIGS. 7 and 8 corresponding to selected channels and key words, respectively. Key words may be added to the list using any suitable mechanism for user entry or selection from a list.

In an embodiment, the data sets for each bead are stored on a network server and accessed through the console 320. The console may generate a uniform resource locator (URL) when activated to do so. Using the identification of one or more beads 310 that have been associated with the action (by touching to the recess, for example), and if necessary the console's 320 own identification, the console can generate a unique URL or other kind of address. Once the address is generated, the data associated with the relevant bead or beads 310 can be accessed to be modified, used, transferred, etc. In a data transfer operation, such as discussed with respect to FIGS. 4 and 5, the data actually may flow from one server address to another server address or URL to which the respective consoles 322 and 324 point.

In an alternative embodiment, some or all of the data may be stored on the console or within the bead. In these cases, it is possible to conduct a transfer or modification of a data set without access to a network. Since the requirement of access to a network is less of a hindrance for a wireless device, the console 320 may be a wireless network terminal.

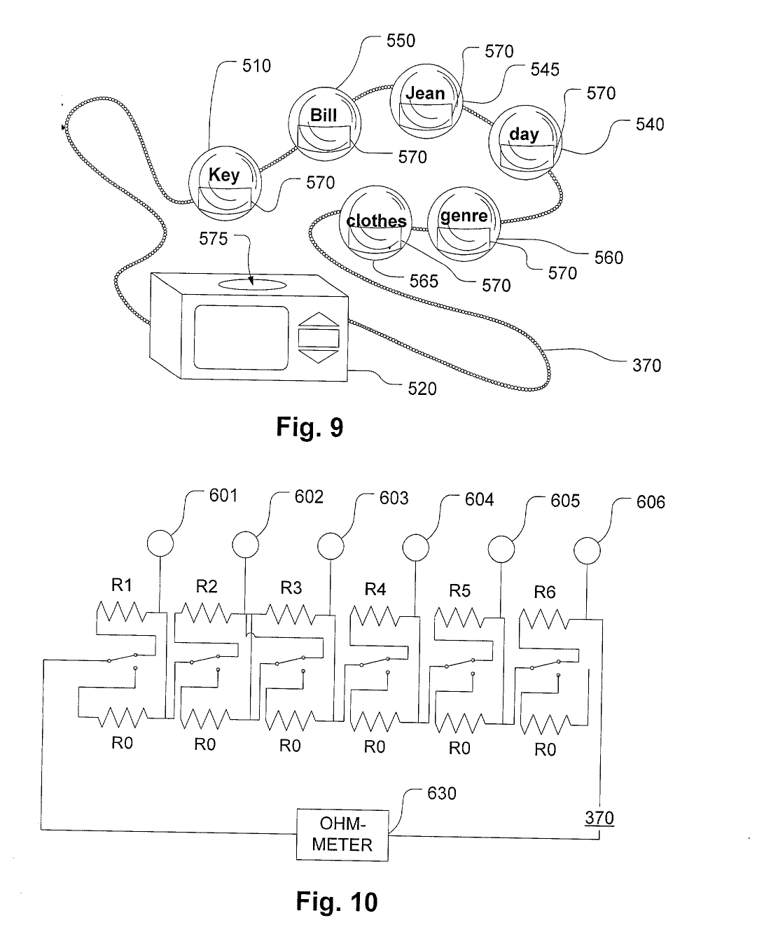

Referring to FIG. 9, in another embodiment, each bead 510, 550, 545, 540, 560, 565 has a display 570. Each bead may have an internal or external switch that allows the display to be changed. For example, the bead could be soft with a pressure sensitive switch inside (not shown) which, when the bead is pinched, scrolls the display. The embodiment could be used in the following fashion to create a new profile. First, a bead to be used as a profile bead, e.g., Bill's bead 550, could be contacted to the console 520 recess 575. The console may be programmed to permit the user to modify or erase the contents of the Bill bead 550 profile. Assume the user indicates a desire to erase the profile on the Bill bead 550. The user may then take each bead in turn, select the particular item in each criterion bead by squeezing the respective criteria bead 510, 540, 560, 565 and, as each selected criterion is displayed, the criterion may be added to the Bill bead 550 profile by touching the respective criteria bead 510, 540, 560, 565 to the recess 575. For example, to add genre=comedy to the Bill bead 550, the Genre bead 560 would be pinched several times until the category “comedy” appeared in its display. Then the Genre bead 560 would touched to the recess 575 and the comedy genre thereby added to the list. Another genre category could be added or another criteria bead 510, 540, 565 could be selected and a selection from that list made.

In another embodiment that uses beads with displays 570 and controls (not shown) and communication devices inside, data can be transferred from one bead 510, 550, 545, 540, 560,. 565 to another by touching a sending bead to a receiving bead. In this case, the beads could be held together and data transferred between them by actuating the switch (not shown) on the sending bead. The console could register this by any of various means. For example, if all the beads are identified by a unique resistance, touching two beads together could short-circuit the resistances of one or more beads one of the beads is effectively identified that way. Referring to FIG. 10, a simple resistance network with each bead housing a pair of resistances, e.g., R1 and R0, connected serially by the bead string or chain 370 can be swapped into or out of the network by an internal single-pole double-throw switch. When a switch is in the normal position, the respective resistances R1-R6 are summed in the network by an ohmmeter 630. When a contact 601-606 of one bead is connected to a contact 601-606 of another bead, the respective resistances of the beads and all those between them fall out of the resistance-sum measured by the ohmmeter 630. So, for example, if the bead with R1 is touched to the bead with R4, the network consists of only resistances R1, R5, and R6. If the resistance values are chosen such that every pairing of contacts 601-606 results in a unique resistance sum being measured at the ohmmeter 630, and the resistance R0 is chosen so that its contribution to the network can always be distinguished, then the console 520 can determine which pair of beads are touching and which has its switch closed. For example, if there are ten beads and the beads have resistances ranging in integral units from 9-18 ohms and R0 has the value of ½ ohm, then the pair that is shorted can be determined from the unique resistance sum of the network and the contribution of R0 can be identified. Other mechanisms for identifying which pair of beads is contacted with another are possible. For example, the console 320 could be provided with two recesses or two beads could be held in the user's hand and respective temperature sensors in each used to actuate a transponder in each that is actuated only when the temperature of the beads is above a certain value. The essential purpose is that some physical association between the objects indicates to a control/storage device as a whole the user's intent to perform some operation with the data that corresponds to each bead.

A very straightforward and simple embodiment is one in which each bead has a transponder or transmitter that is activated in response to a switch. For example, each bead could have a transmitter that transmits only when body heat raises the beads temperature above a certain level. Then, when any of the beads are held in the hand, the data sets associated with those beads would be active. For example, say a user has beads for Jill, Michael, and Jean's preferences. The user could pick up only Michael's bead and review EPG choices through Michael's preferences. Alternatively, Michael's and Jill's preferences could be summed by picking up both the Michael and Jill beads and holding them until both transmitters generated signals.

Note that although in the embodiments described above, data sets are associated with beads 310, it is possible to associate data sets with any kind of object. They could be tokens, game pieces, small toys, building blocks, etc. The important feature is that data sets are associated with objects. Note also that while in the above embodiments, a recess 375 is used to interface the console 320 and a bead 310, the interface could be established by any of a number of different devices. For example, the interfaced bead could be brought in proximity and connected via a wireless link. It could be pushed into a hole in the console or a placed in a pop-out basket of the console. The bead could be placed inside a trap in the console. Many different possibilities exist and believed to be within the scope of the invention. Note that the above comments also apply to interfacing one bead with another as in the example discussed with respect to FIG. 10.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A user interface, comprising:
at least two objects, each associated with a respective data set consisting of at least one datum;
a controller connected to a data store and programmed to perform an operation on said respective data sets;
said controller having a receiver;
at least one transmitter operatively associated with said at least two objects and responsive to a mechanical state of said at least two objects such that a control signal is transmitted to said receiver corresponding to an operation to be performed on at least one of said data sets and responsive to at least the other of said data sets, said controller being programmed to perform said operation.

2. A user interface as in claim 1, wherein said at least two objects are tokens connected by a chain, a wire, string, or filament.

3. A user interface as in claim 2, wherein said at least two objects are beads.

4. A user interface as in claim 1, further comprising a console operatively associated with said at least two objects, said console housing said transmitter.

5. A user interface as in claim 4, wherein said console has a display and at least one control switch, said control signal being responsive to data entered through said at least one control switch and an image of said display being responsive to said control switch.

6. A user interface, comprising:
a mechanically connected combination of tokens, each associated with a data set;
a console interoperable with said tokens;
said console having a controller, a transmitter, and an interface;
said controller being programmed such that a first mechanical configuration of one of said tokens, effective to interface said one of said tokens with said console, results in the transmission of a command indicating a data exchange operation involving said data set associated with said one of said tokens.

7. A user interface as in claim 6, wherein said console has at least one control switch to which said command is responsive.

8. A user interface as in claim 6, wherein said tokens are beads connected by one or more flexible connectors.

9. A user interface as in claim 6, wherein said interface includes a contact elements that is configured to permit said controller to detect a presence of a one of said tokens that is in contact with said interface.

10. A user interface as in claim 6, wherein each of said tokens contains a unique encoded signature transmittable to said controller via said interface such that said controller may distinguish among said tokens.

11. A user interface wherein each of said tokens has a device containing a code uniquely identifying said token such that said controller can distinguish between said tokens.

12. A system for controlling a delivery of data to a terminal, comprising:
tokens, each corresponding to a set of criteria pertaining selectively to a subset of said data;
each of said tokens encoding an identifier;
a transmitter operatively associated with said tokens;
a data delivery terminal with a receiver for delivering said data to said terminal for display thereon;
said transmitter being responsive to said identifier of at least a selected one of said tokens such that a command to filter said data is generated by said transmitter.

13. A system as in claim 12, wherein said criteria are stored on a server connected to said data delivery terminal, said identifier being used by said terminal to derive a unique server address of said server.

14. A method of accessing data, comprising:
encoding tokens with unique identifiers;
storing an address on a communication station, said address pointing to a respective data set for each of said tokens;
transmitting commands to said communication station to transfer from a first data set to a second data set responsively to a manipulation of said tokens corresponding to said first data set and said second data set.

15. A method as in claim 14, wherein said manipulation includes forming a communication connection between a console and said tokens corresponding to said first and second data sets.

16. A method as in claim 14, wherein said step of transmitting includes transmitting said unique identifiers of said tokens corresponding to said first and second data sets.

17. A method of accessing data, comprising:
encoding tokens with unique identifiers;
storing an address on a communication station, said address pointing to a respective data set for each of said tokens;
manipulating said tokens;
transmitting commands to said communication station to filter data delivered to said terminal responsively to criteria defined by said first data set and said second data set;
said step of transmitting being responsive to a result of said step of manipulating.

18. A method as in claim 17, wherein said step of manipulating includes bringing said tokens corresponding to said first and second data sets into proximity with a console and transferring said unique identifiers to said console.

19. A method as in claim 18, wherein said step of transmitting includes transmitting said unique codes of said first and second data sets.
